(19) United States
(12) Patent Application Publication
(10) Pub. No.: US 2022/0401986 A1
(43) Pub. Date: Dec. 22, 2022

(54) CONTROL OF DUST FORMATION IN DEMOLITION WORK WITH A TOOL-CARRYING WORK VEHICLE

(71) Applicant: BROKK AKTIEBOLAG, SKELLEFTEÅ (SE)

(72) Inventor: Stefan ANDERSSON, SKELLEFTEÅ (SE)

(21) Appl. No.: 17/756,102

(22) PCT Filed: Oct. 27, 2020
(86) PCT No.: PCT/SE2020/051038

§ 371 Date: May 17, 2022

(30) Foreign Application Priority Data
Nov. 19, 2019 (SE) 1951332-4

(51) Int. Cl. B05B 13/00; B05B 13/04; B08B 15/00; E21F 5/04

(52) U.S. Cl. CPC B05B 13/005; B05B 13/0431; B08B 15/00; E21F 5/04; B08B 2215/003

(57) ABSTRACT

The invention relates to a work vehicle (1) comprising an operable arm (10) adapted to handle a tool (A-D) fastened to the free end of the arm, a control unit (4) for controlling the work vehicle (1), a dust control system arranged to distribute water mist with the aim of retaining dust that is created when the tool is used. For efficient dust control, the dust control system comprises a pressure air source (31) and a water pressure source (21), an air duct (33) arranged for the tool (A-D), through which an airflow from the pressure air source (31) can be conveyed, an injection nozzle (26) directed against the airflow in the air duct (33), with which water from the water pressure source (21) can be sprayed into the airflow for atomization of the water into liquid drops, which together with the airflow form a water mist, whereby the air duct arranged for the tool (A-D) is directed, so that the liquid drops form water mist (36) in the surroundings of the tool.

### TECHNICAL FIELD

The present invention relates to a tool-carrying work vehicle with a device for dust control in connection with demolition work according to the preamble of claim 1. The invention also relates to a method for limiting dust formation in connection with demolition work with a tool-carrying work vehicle according to the preamble of claim 10.

### BACKGROUND

A work vehicle such as a wrecking or demolition robot demolition is a remote-controlled working machine travelling on tracks, which at a free end of an operable arm can carry various types of tools for various types of work tasks. As examples of tools, chipping hammers for demolition and wrecking work can be mentioned. An operator usually walks beside the machine and controls its various movements. The operator is in communication with the machine via cables or wirelessly, for example via Bluetooth or radio control. The operator controls the machine by means of a remote control with two control sticks, and a series of various buttons and handles. The machine can be adjusted into various work settings, so-called modes, by means of a handle. The control sticks and the controllers usually have different functions depending on the selected working mode. In a first transport mode, the machine is driven up to the work area, for example to a wall that is to be demolished. Then the support legs are folded down, so that the machine stands steadily. This is a setting mode. The actual demolition work subsequently begins with the remote control in a working mode.

In case of crushing, grinding and similar processing of material such as concrete, stone or plaster, particles are formed in the form of powder and dust. Dust can be very unhealthy for the operator or other personnel staying close to the work area. A common way of preventing dust from spreading in demolition and wrecking work is to bind the dust through water sprinkling. A disadvantage of this is that relatively large amounts of water are consumed, and at the same time the ability to bind dust is relatively low.

An example of such watering is described in patent application no. SE 1750014 A1, wherein water is sprayed out from a spray nozzle at the tool that is actuated by the working machine and towards the work area of the tool. The amount of water can be varied with regard to the tool that is coupled to the working machine. From JP 2005171517 A is known a working machine having a driver's cabin and a crane, which at its free end carries a tool. The working machine includes a system for dust control with a liquid mist that uses sputtering nozzles or jets. The driver's cabin of the working machine comprises a control panel with which the dust control system can be controlled.

### SUMMARY OF THE INVENTION

A disadvantage of the prior art tool-carrying working machines that use jets or sputtering nozzles to achieve a dust control liquid mist is that they require a very high water pressure, not infrequently between 250-300 MPa and hence also advanced pumps and other expensive equipment to achieve this. Moreover, the high water pressures lead to a high water and energy consumption, and jets and nozzles to achieve the desired drop size by means of sputtering are susceptible to filling of particles and ice formation. It is known that the relative size of a liquid drop has significant importance to its ability to bind dust particles of varying sizes. For efficient dust control, it is necessary not only to know the particle size of the dust, but also to obtain correspondingly sized water drops. A fine liquid mist consisting of a high proportion of drops with a size of about 10 μm has proved suitable for binding and controlling dust with a particle size varying between 10 and 55 μm or less. It should be pointed out that usually specific particles smaller than 10 μm (<10 μm) are particularly harmful to health and can cause lung disease when inhaled.

In some cases, the access to water can be limited at a work site for the work vehicle concurrently with the space and weight limitations of the work vehicle are restricting. This means that a work vehicle of the present type is neither adapted or suitable for carrying considerable amounts of water in itself. A small and light device for dust control with low water consumption, few litres per minute, is thus desirable.

A first object of the present invention is therefore to achieve a work vehicle that offers an efficient way of controlling dust formation. A second object of the invention is to achieve a work vehicle, which can provide liquid drops of varying sizes without requiring delicate, costly, space-consuming or heavy equipment for the work vehicle. A third object of the invention is to achieve a work vehicle with a fully-automated intelligent device for dust control. A fourth object of the invention is to suggest a method for limiting dust formation in connection with demolition work with a work vehicle.

Said first and second objects of the invention are achieved by a work vehicle having the features and characteristics stated in claim 1. Said third object of the invention appears from the characteristics of claim 7. Said fourth object of the invention is achieved by a method having the features and characteristics stated in claim 10. Further advantages of the invention appear from the dependent claims.

The insight that forms the basis of the invention is a work vehicle equipped with a device that produces liquid drops by water, via a nozzle, being spayed into an airflow that is discharged from an air duct can generate a liquid mist that efficiently can bind the type of dust particles that are typically formed in connection with demolition and wrecking work with for example building material, such as concrete, rock material or the like. By conveying the airflow through an air duct, the pressure liquid can simply be sheared into liquid drops of varying sizes by changing the velocity of the pressure air through the air duct and at the same time the pressure of the pressure water can be regulated or alternatively be kept constant, whereby only the air velocity is regulated. Drops of varying sizes can thus be obtained to efficiently bind occurring dust particles, the sizes of which can vary significantly, depending on specific features of the material being demolished and the specific tool that the demolition robot uses for the work.

According to an embodiment, the dust control system comprises a pressure air source and a water pressure source, an air duct, arranged for the tool, through which an airflow from the pressure air source can be conveyed, an injection nozzle, directed against the airflow in the air duct, by means of which water from the water pressure source can be spayed into the airflow for atomization of the water into liquid drops, which together with the airflow form a water mist, whereby the air duct arranged for the tool has an outlet that is directed, so that the liquid drops form water mist in the surroundings of the tool.

According to a second embodiment, the control unit comprises a first operator interface, which allows the choice of at least one tool, wherein each such choice is associated with a certain predefined parameter setting of the velocity of the pressure air through the air duct, the working pressure of the pressure water to the injection nozzle or a combination thereof to obtain a size of the formed liquid drops corresponding to the selected tool.

According to a second embodiment, the control unit comprises a second operator interface, which allows the choice of at least one tool, wherein each such choice is associated with a certain predefined parameter setting of the velocity of the pressure air through the air duct, the working pressure of the pressure water to the injection nozzle or a combination thereof to obtain a size of the formed liquid drops corresponding to the selected material.

### DESCRIPTION OF FIGURES

In the following, an exemplary embodiment of the invention is described in further detail with reference to the accompanying drawing, in which;

FIG. 1 shows a first view of a work vehicle equipped with a device for producing and diffusing a liquid mist in the work area for a tool according to the invention;

FIG. 2 schematically shows a line system for providing the dust formation device of the work vehicle with the required pressure water and pressure air, respectively, and

FIG. 3 schematically shows a view of a remote control with an intelligent system, which according to the invention automatically adapts the size of the liquid drops to efficiently form dust particles, the size of which can vary, partly depending on the tool that is coupled to the work vehicle, and partly on the type of material that the tool is intended to process.

### DESCRIPTION OF EMBODIMENTS

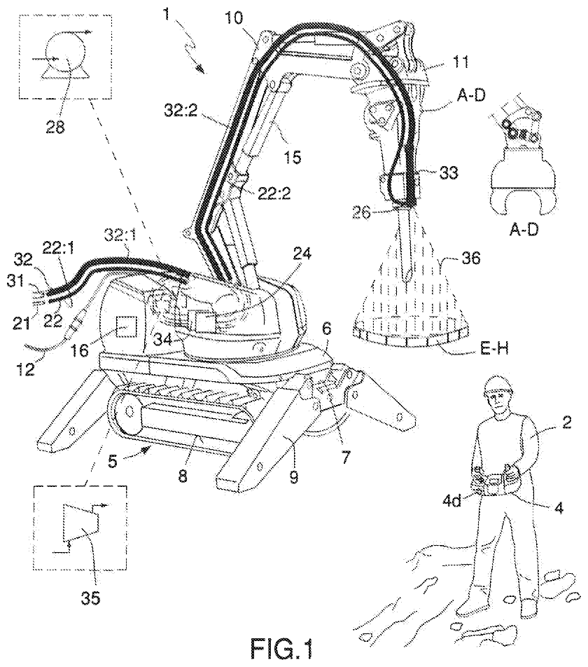

FIG. 1 further shows a work vehicle in the form of a demolition robot 1 equipped with a device for producing and diffusing a liquid mist in the work area for a tool according to the invention. The device includes a pressure water source and a pressure air source, respectively, which suitably are available from external networks on the work site, on which the work vehicle is operated. In another embodiment, the work vehicle 1 must be able to hold suitable internal sources, which can provide pressure water and pressure air, respectively.

An operator 2 (machine operator) walks beside the work vehicle 1 and remote-controls it wirelessly via a remote control device 4, comprising a transmitter/receiver unit. A chassis with a carriage having a top carriage 6 and an undercarriage 7 is generally denoted 5. The top carriage 6 is twistably bedded on the undercarriage 7 for swinging in a horizontal plane. The undercarriage 7 is equipped with a propulsion device comprising tracks 8. Support legs are denoted 9 and are operated by associated hydraulic cylinders, and an operable arm means, denoted 10, is sustained on the top carriage 6 and is operable by means of hydraulic cylinders. A cable is denoted 12 and is intended to be connected to a stationary three-phase electric power grid to provide the work vehicle 1 with electric power. The arm means 10 is at its free end provided with a tool attachment 11, a so-called snap fastener, to which various types of tools A-D can be attached and connected for hydraulic operation. Said tools A-D can comprise a hydraulically powered chipping hammer, which is shown in the figure, a pair of scissors, a saw, a rotatable shear blade to mention a few examples.

As shown in FIG. 1 and FIG. 3, the remote control device 4 comprises impact means such as control sticks 4a and buttons 4b and handles R, which can be operated by the operator 2 to control and monitor the various functions of the work vehicle 1. Via the remote control device 4, the operator 2 may set the work vehicle 1 in various operating or usage conditions. Depending on the selected operating mode, the impact means will control various functions of the work vehicle 1. The choice of operating mode and other information of importance to the operator 2 can be shown in an indication means in the form of a display unit 4c on the remote control device 4. The arm means 10 comprises, at its ends, a number of articulately joined arm parts, which are mutually moveable by impact of hydraulic cylinders 15. The hydraulic cylinders 15 are controlled by means of a valve block 16 with electro-hydraulically operative valves, which are accommodated in the pivotable part of the top carriage 6 of the work vehicle 1. The hydraulic valve block 16 enables regulating a flow of a hydraulic fluid to each of the consumers of the work vehicle.

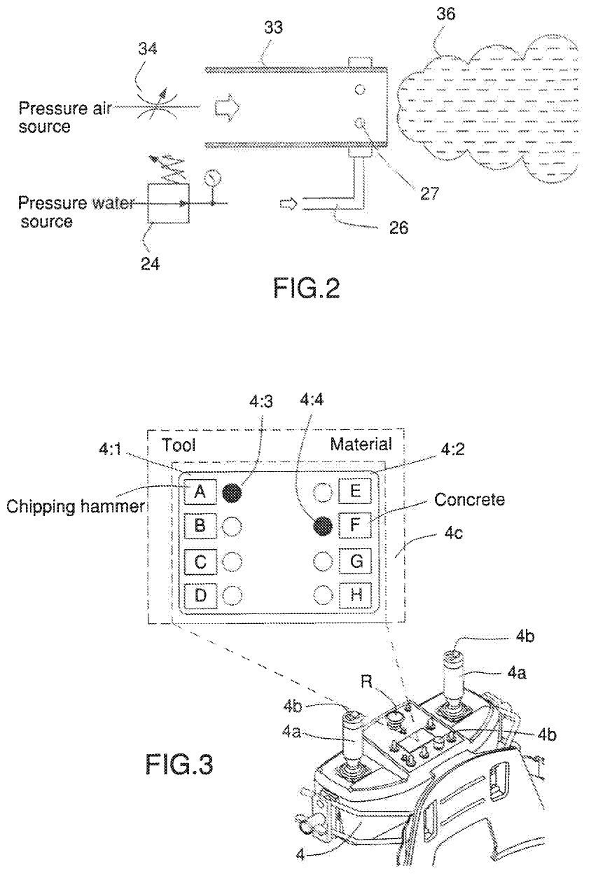

Also referring to FIG. 2, a schematic view is shown of an external pressure water supply included in the work vehicle 1, an external water line in the form of a water pressure source 21 connected to a water inlet 22 of the work vehicle 1, wherein the water inlet 22 is connected to a first water line 22:1, which is connected to and arranged to convey water to a, via the remote control device 4, manageable and controllable pressure water-controlling valve 24 by which the water pressure source's 21 work pressure can be regulated. In an alternative embodiment, in which the work pressure of the water pressure source is kept constant, the work vehicle 1 can comprise a pressure-reducing valve 24 (not shown. The task of the pressure-reducing valve 24 is thereby to ensure that the water pressure is kept at a constant and predetermined level at a predetermined work pressure, which preferably is somewhat lower than an applicable system pressure, as it is well known that the system pressure of external water networks can be both unstable and varying. Said pressure water-controlling valve 24 is in turn connected to a second water line 22:2 arranged to convey the water to an injection nozzle 26 in close connection to the tool A-D. The pressure water source 21, the water inlet 22, the first water line 22:1, the pressure water-controlling valve 24 (alternatively a pressure-reducing valve 24), the second water line 22:2, the injection nozzle 26 together form a water supply arrangement. As shown in a partial enlargement in FIG. 1, the work vehicle can in an alternative embodiment, if necessary, be equipped with an internal pump 28 to provide water with the required pressure and flow if the current work site of the work vehicle 1 lacks the required external water line or water pressure source.

Moreover, also referring to FIG. 2 a schematic view is shown of an external pressure air supply included in the work vehicle 1 in the form of an external pressure air line or pressure air source 31 connected to a pressure air inlet 32 of the work vehicle 1, wherein the pressure air inlet 32 is connected to a first pressure air line 32:1, which is connected to and arranged to convey pressure air to an adjustable pressure air-controlling valve 34 via the remote control 4. The remote control device 4 includes a regulator R (see FIG. 3) on the remote control device 4 with which said pressure air-controlling valve 34 can be controlled and checked manually by the operator 2. Said pressure air-controlling valve 34 is in turn connected to a second pressure air line 32:2 arranged to convey pressure air to an air duct 33, consisting of a tube through which a strong airflow can pass and to which air duct the above-mentioned pressure water-conveying injection nozzle 26 is coupled in close connection with an outlet 35 of the air duct 33. The pressure air source 31, the pressure air inlet 32, the first pressure air line 32:1, the second pressure air-controlling valve 34, the second pressure air line 32:2 and the air duct 33 together form a pressure air supply arrangement.

As shown in a partial enlargement in FIG. 1, the work vehicle 1 can, if necessary, be equipped with a compressor 35 to provide air with the required pressure and flow, whereby where applicable said can constitute a pressure air source if the if the current work site of the work vehicle lacks the required external pressure air line.

When the tool A-D is mounted onto the work vehicle 1, said combination of air/water is thus arranged to the work vehicle in such a manner that the water supply 21 is connected to the injection nozzle 26 via the pressure water-controlling valve 24, wherein said valve does not necessarily need to be used with a pressure-controlling aim, but only to open/close the water supply to the water nozzle 26 (on/off regulation), if the system pressure of the pressure source in itself is so stable that this is possible. The pressure water should have a work pressure, which is lower than 20 MPa, preferably between 3-10 MPa. As shown in FIG. 2, the injection nozzle 26 ends in one or a plurality of outlet apertures 27 inside the free end of the air duct 33. Furthermore, the pressure air supply 31 is connected to the air duct 33 via the pressure air-controlling valve 34 whereby the velocity of the air flow that is conveyed to the air duct 33 can be varied by switching the degree of opening of the pressure air-controlling valve 34. The occurring airflow through the air duct 33 is strong and can have velocities of between 30-300 m/s. The airflow velocity through the air duct 33 is preferably at least 30 m/s.

When water, via the injection nozzle 26 apertures 27, is injected into the airflow passing through the air duct 33, an atomization of the liquid into small liquid drops is obtained. Subsequently, the liquid drops continue with the airflow and form a mist 36. By varying the velocity of the airflow, the size of the liquid drops can be varied. Alternatively, the size of the liquid drops can be varied by varying the work pressure of the water being injected via the injection nozzle 26. As mentioned initially, the size of the liquid drops are highly decisive for how efficiently dust particles of varying sizes can be bound.

FIG. 2 schematically and in more detail shows parts of a line system for providing the dust formation device of the work vehicle 1 with the required pressure water and pressure air, respectively, from a respective source. Thus, the air duct 33 comprises the above-mentioned tube through which the strong airflow passes. In connection with an outlet 35 at the free end of the air duct 33, said outlet apertures 27 for water injection end. In connection with the area, where the airflow leaves the air duct 33, water is thus sprayed or injected into the airflow via the outlet apertures 27. The airflow, which has a relatively high velocity (>30 m/s), thereby atomizes the spayed in liquid into small drops, which are diffused and form said liquid mist 36. It should be understood that the outlet apertures 27 for the water not necessarily need to be arranged inside the air duct 33, but they can correspondingly be arranged somewhat outside or after the air duct's 33 outlet 35 (not shown).

With reference to FIG. 3, the remote control 4 is schematically shown as it is seen by the operator 2. In addition to said control sticks 4a and buttons 4b, the display unit 4c has an optional user interface with a first user interface zone 4:1, which in the form of selection elements show a number of optional tools A-D, a second user interface zone 4:2, which shows a number of optional materials E-H. Said tools A-D can for example comprise a chipping hammer, a rotatable saw blade etc., and said material can for example comprise various types of common material E-H that the work vehicle normally demolishes or wrecks, particularly dust-generating material such as concrete, stone material, plaster or the like. Both user interface zones 4:1, 4:2 are oriented in mutually parallel lines and are placed on opposite sides (right/left-side) of the display unit 4c. in response to choices that are made by the operator 2, control symbols 4:3, 4:4 are activated, indicating choices by lighting. As appears from FIG. 2, said control symbols are arranged in lines next to said first and second user interface zones 4:1; 4:2, respectively.

Furthermore, the work vehicle 1 comprises a computer 4d or the like with software, which on the basis of the operator's 2 choice of tool and a material in said user interface zones 4:1, 4:2 automatically selects suitable process parameters for said water supply arrangement and pressure air arrangement, respectively, in such a manner that the mist-formation structure and size of the liquid drops formed are adapted in an optimum manner to efficiently bind the particles that can be expected to be formed during work with the selected tool and/or the selected material. The computer 4d is accommodated in the remote control device 4.

This means that when the work vehicle 1 is started, a plurality of modes or positions in the corresponding generically indicated fields A, B, C, D respectively E, F, G, H are shown on the display 4c, and the operator 2 selects the desired tool and material with the relevant buttons 4b on the remote control device 4 or directly on the display unit 4c by pointing to graphic fields on it. In the cases where the operator 2 selects any of the optional tools A-D in the first user interface zone 4:1 and/or any of the indicated materials E-H in the second user interface zone 4:2, based on the operator's 2 choices, the software will retrieve suitable process parameters to create an adequate mist formation. The computer 4d executes a program, which automatically controls the water supply arrangement and the pressure air supply arrangement, respectively, in a predetermined manner. More specifically, each such choice is associated with a certain predefined velocity of the airflow that is conveyed through the air duct 33, the working pressure of the pressure water to the injection nozzle 26 or a combination thereof to obtain a size of the formed liquid drops corresponding to the selected tool or material.

If neither a tool nor a material is selected in said respective user interface zones 4:1, 4:2, the indicated control symbols on the display unit 4c will be turned off. In case of no such choice, the operator 2 can choose to manually control and check the structure of the mist formation and also choose the size of the drops by means of the regulator R on the remote control device 4. If so, the operation of the regulator R implies that the velocity of the airflow conveyed through the air duct 33, the work pressure of the pressure water to the injection nozzle 26 or a combination thereof, can be controlled to achieve the desired size of the formed liquid drops and/or geometrical structure and distribution of the liquid mist.

It could be mentioned that also at automatic operation, when the computer 4d controls the water supply arrangement and the pressure air arrangement, respectively, the operator 2 can at any time overrule the computer 4d and manually control and regulate operational parameters by means of the buttons and controls 4b as well as the regulator R of the remote control device 4. The latter thus makes it possible for the operator 2, also during automatic operation, to fine-tune mist formation and drop size through the influence of the above-mentioned process parameters by means of the manual regulator R. According to an embodiment, the computer 4d is where relevant equipped with both a read-write memory as well as a permanent memory for data storage, which makes it possible to save two or more specific mist formation settings for a tool A-D and/or a material, which in practice in a specific work process has proved to be well-functioning and preferred by the operator 2. All air/water lines are in the form of tubes, hoses or the like.

1. A work vehicle, comprising:
an operable arm adapted to handle a tool fastened at the free end of the arm,
a control unit for controlling the work vehicle, and
a dust control system arranged to distribute water mist with the aim of retaining dust that is created when the tool is used,
wherein the dust control system comprises:
a pressure air source and a water pressure source,
an air duct arranged for the tool, through which an airflow from the pressure air source is configured to be conveyed, and
an injection nozzle, directed against the airflow in the air duct, with which water from the water pressure source is configured to be sprayed into the airflow for atomization of the water into liquid drops, which together with the airflow form a water mist, whereby the air duct arranged for the tool is directed, so that the liquid drops form water mist in the surroundings of the tool.

2. The work vehicle according to claim 1, further comprising a pressure air-controlling valve, with which the velocity of the airflow that is conveyed through the air duct can be regulated.

3. The work vehicle according to claim 2, wherein the airflow velocity through the air duct can be regulated in an interval between 30-300 m/s.

4. The work vehicle according to claim 1 further comprising a pressure water-controlling valve with which the work pressure of the water pressure source to the injection nozzle can be regulated.

5. The work vehicle according to claim 4, wherein the water has a work pressure, which is lower than 20 MPa.

6. The work vehicle according to claim 2, wherein the control unit comprises a regulator with which the opening degree of pressure air-controlling valve or the injection pressure of the pressure water-controlling valve can be regulated manually.

7. The work vehicle (1) according to claim 1, wherein the control unit comprises a first operator interface, which allows the choice of at least one tool, wherein each such choice is associated with the setting of at least one of the following process parameters; a certain pre-defined parameter setting of the velocity of the pressure air through the air duct, the working pressure of the pressure water to the injection nozzle or a combination thereof to obtain a size of the formed liquid drops corresponding to the selected tool.

8. The work vehicle according to claim 1, wherein the control unit comprises a second operator interface, which allows the choice of at least one type of material, wherein each such choice is associated with the setting of at least one of the following process parameters; a certain pre-defined velocity of the pressure air that is conveyed through the air duct, the working pressure of the pressure water to the injection nozzle or a combination thereof to obtain a size of the formed liquid drops corresponding to the selected material.

9. The work vehicle according to claim 1 further comprising a demolition robot, wherein the control unit comprises a remote control device intended to be carried by an operator.

10. A method for dust control in connection with demolition work with a work vehicle having, at a free end of an operable arm, a fastened tool, the method comprising:
arranging a pressure air source,
arranging a water pressure source,
producing a liquid mist by the water from the water pressure source, and
injecting the liquid mist in an airflow from the air pressure source,
wherein the airflow atomizes the water into liquid drops and diffuses the liquid drops as a liquid mist, and that the liquid mist formed in this manner is diffused in a work area for the tool for absorption of dust that is created when the tool is used.

11. The method according to claim 10, wherein the airflow is produced in an air duct arranged for the tool.

12. The work vehicle according to claim 2, wherein the airflow velocity is at least 30 m/s in the air duct.

13. The work vehicle according to claim 5, wherein the water has a work pressure between 3-10 MPa.

14. The work vehicle according to claim 4, wherein the control unit comprises a regulator with which the opening degree of pressure air-controlling valve or the injection pressure of the pressure water-controlling valve can be regulated manually.
